(19) United States
(12) Patent Application Publication
(10) Pub. No.: US 2004/0017773 A1
(43) Pub. Date: Jan. 29, 2004

(54) Method and system for controlling the rate of transmission for data packets over a computer network

(75) Inventors: Christopher King Piche, West Vancouver (CA); Adam Rotaru, Satu Mare (RO); Shahadatullah Khan, West Vancouver (CA); Junhai Qiu, North Vancouver (CA); Jozsef Vass, North Vancouver (CA); David Everett Marwood, North Vancouver (CA)

Correspondence Address: Paul Hildebrand, Vice President, Eyeball Networks Inc., Suite 500, 100 Park Royal, West Vancouver, BC, V7T 1A2, CA

(73) Assignee: Eyeball Networks Inc., West Vancouver (CA)

(21) Appl. No.: 10/200,379

(22) Filed: Jul. 23, 2002

(51) Int. Cl. G01R 31/08; H04L 12/66; H04L 12/28

(52) U.S. Cl. 370/232; 370/351; 370/400

(57) ABSTRACT

The present invention provides a window-based method for controlling the rate of data transmission for computer software applications transmitting data using packet switched protocols. The method is suitable for real-time applications, such as Internet video conferencing, which require low transmission latency, and which can tolerate some level of packet loss.

### BACKGROUND OF THE INVENTION

The present invention relates to the field of data transmission over an information network. More particularly, the present invention relates to the transmission of real-time data over a computer network using packet switched transmission protocols, such as the User Datagram Protocol (UDP).

Different protocols are used to regulate the transmission of data over computer networks. The TCP/IP suite of protocols is used to transmit data over the Internet, a worldwide network which connects a large number of individual computer networks. The two principal protocols by which host computers organize data for transmission to other host computers over the Internet are Transmission Control Protocol (TCP) and User Datagram Protocol (UDP). TCP is used, for example, to organize the transfer of files over the Internet and the transmission of e-mail. UDP is more commonly used for real-time interactive applications, such as video conferencing.

Both TCP and UDP organize data into packets. The Internet includes a series of routers, which transmit individual packets along the Internet, from one router or network to the next, until they arrive at their intended destinations. Because a large number of computers use the Internet simultaneously, the traffic levels along different branches of the Internet vary substantially. From time to time, packets may arrive at a given router faster than the router can process them, to transmit them to the next router or to a destination network. Routers typically have buffer memories, which can store a backlog of packets. However, if enough packets arrive at a given router quickly, the router's buffer may be filled. When this happens, the router discards newly arriving packets until space in the memory buffer comes free. Some packets sent over the Internet are lost—a phenomenon known as packet loss.

The different characteristics of TCP and UDP determine which protocol is best suited for a particular application. The principal difference between the two is that TCP is a reliable data transmission protocol, while UDP is not. TCP ensures that each data packet sent from a source computer is received by the intended recipient. To accomplish this, TCP causes the recipient to send an acknowledgement to the source, confirming delivery of each packet received. The host computer will transmit a packet a second time if it does not receive acknowledgement, within a specified period of time, that the packet was successfully delivered. UDP does not include a similar method for identifying and re-transmitting lost packets; UDP is an unreliable protocol, and subject to packet loss.

Because it is reliable, TCP is the appropriate protocol for applications which cannot tolerate packet loss. For example, transmission of data files or text messages is not practical without a means of ensuring that all of the data is transmitted. However, the TCP method of preventing packet loss renders it unsuitable for some applications. When a packet is lost, the recipient will not receive packets in the same order they were sent. This can also occur when different packets travel different paths on their way from source to destination. TCP numbers packets, so that the recipient can reconstruct their original order. When a packet is lost, so that the next packet is received out of order, TCP halts the processing of data to wait for the replacement copy of the lost packet. When the replacement packet arrives, TCP arranges the packets in their correct order, and data processing continues. The delays involved in this process make TCP unsuitable for applications which are highly time-sensitive, and which can tolerate some level of packet loss.

An example is real-time video conferencing, which typically uses UDP to avoid delays that TCP would create in retransmitting lost packets. As a UDP application, video conferencing will be subject to packet loss, which may degrade image quality. However, modem coding technology can reduce the impact of packet loss, so that an acceptable quality image is still available. The advantages of UDP in avoiding retransmission delay outweigh the disadvantage of packet loss, and are essential to real-time video conferencing applications.

Another difference between TCP and UDP is in the rate at which they transmit data. TCP includes a procedure for regulating the rate at which packets are transmitted. This procedure serves both objectives of individual users and objectives of the Internet as a whole. Transmitting data at too high a rate can cause memory buffers along the Internet to become overloaded, resulting in increased packet loss. This makes the service available to individual users less efficient, and also reduces the stability of the Internet.

TCP uses a window based rate control method. TCP establishes a window size, which limits the total number of packets which are either in transit, or which can be transmitted immediately. The window size depends on the amount of the buffer space the receiver has offered and the amount of traffic allowed on the network. The operation of a window based rate control method is illustrated in FIG. 1.

Each time another packet is acknowledged by the recipient, the left edge of the window moves one packet to the right, reducing the window size. To restore the window to its specified size, another packet is added to the window, and thus becomes available for transmission. TCP increases or decreases a computer's sending rate by increasing or decreasing the specified window size. When packet loss is detected, the window size is reduced to reduce the transmission rate. As transmission proceeds without packet loss, the window size is increased to exploit unutilized transmission capacity. TCP changes window size according to an additive increase, multiplicative decrease (AIMD) algorithm. When congestion is detected, the window size is reduced rapidly. The increase in window size, when loss-free transmission is being experienced, is more gradual.

UDP does not include a method for regulating transmission rates. UDP transmits packets as they become available. This creates a risk that UDP applications will experience high packet loss, if packets are consistently transmitted at a rate well above sthe capacity of the Internet link being used. To avoid this risk, computer applications which invoke UDP must create their own method of rate control.

The simplest way to regulate transmission of UDP data would be to transmit the data at a fixed rate (i.e. a fixed number of packets or bits per second). However fixed rate transmission will underutilize capacity if the transmission rate is too low, or cause high levels of network congestion if the rate is too high. The transmission rate could be adjusted based on specified parameters, but rate control methods of this nature are typically sensitive to error. Some of the parameters used in adjusting the transmission rate will only be known approximately, as they must be estimated by analyzing system performance. Relatively small errors in estimating required parameters can lead to transmission rates which diverge significantly from optimal values, leading to the same adverse results as fixed rate transmission.

The window-based rate control algorithm of TCP also does not provide a suitable method of rate control for many UDP applications. For example, the TCP method of rate control is not suitable for real-time video conferencing. There are two principal reasons. First, the TCP method of rate control results in relatively volatile changes in transmission rate, which would lead to volatile changes in image quality. Second, the TCP method only reduces the sending rate when packet loss is detected. No adjustment is made when system buffers are nearly full, even though this condition can result in data packets moving more slowly from source to destination (known as increased latency). Increased latency is not a serious disadvantage to most TCP applications, which are not highly time-sensitive. However, many UDP applications are highly time-sensitive, and will benefit from a method of rate control which attempts to reduce or minimize latency. What is needed is a method of rate control for UDP applications which optimizes transmission rates given the objectives of UDP applications.

### SUMMARY OF THE INVENTION

The present invention provides a window-based method for controlling the transmission rate of UDP data packets over a computer network, adjusting the size of the window to reflect estimates of the transmission power of the computer network.

### BRIEF DESCRIPTION OF THE DRAWINGS

FIG. 1 is a depiction of the window-based rate control method.

FIG. 2 is a schematic depiction of a computer network such as the Internet showing data packets passing through a series of routers.

FIG. 3 is a graph showing the effect of different transmission rates on packet loss rate, throughput and latency (round trip time).

### DETAILED DESCRIPTION

FIG. 2 shows a schematic depiction of a computer network 100 such as the Internet, which transmits data packets from a source computer 112 to a recipient computer 114 through a series of routers 116(1)-(N). Each router has an associated memory buffer 118(1)-(N). (The calculations set out below, based on FIG. 2, disregard data being transmitted by other users, and are thus an abstraction from actual operating conditions of the Internet. However, the calculations illustrate the basis and substance of the method of the invention).

The power of the link between source computer 112 and recipient computer 114, designated P₀, is defined in the following way. Assume that the link has a maximum throughput of data packet equal to T₀, measured in bytes/second, in the condition where there is no backlog of data in any of the memory buffers. Assume also that the transit time for a data packet from source computer 112 to recipient 114 is equal to R₀, measured in units of time. To and Ro are parameters of the network 100, and are assumed constant. Then the power P₀ is equal to:

P₀=T₀×R₀.

P₀ is equal to the maximum amount of data which can be in transit at any time, in the condition where no backlog of data is stored in any of the memory buffers 118(1)-(N).

If the buffers begin to fill, two effects occur. First, the amount of data that can be in transit increases, owing to the data stored in the buffers. In addition, the transit time for a packet from the source computer to the recipient computer increases, owing to the time which packets spend in the memory buffers. The total amount of data which can be stored in the buffers is designated as P_{buf}, which is also a parameter of network 100, and assumed constant. The maximum total amount of data which can be in transit, in the condition where all of the buffers are full, is designated as P_{Crit}, and is equal to:

P_{Crit}=P₀+P_{buf}

The maximum transit time, or latency of the link, when all of the buffers are full, is equal to:

Rₘₐₓ=R₀+P_{buf}/T₀=P_{Crit}/T₀

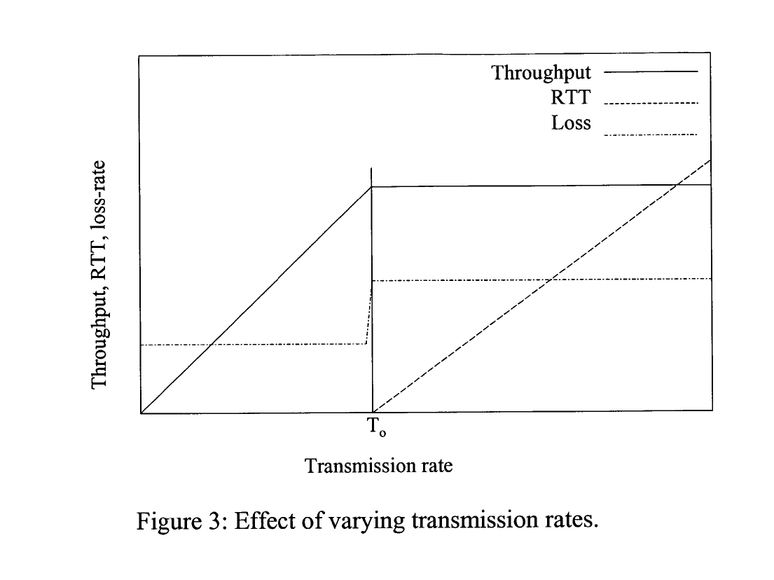

FIG. 3 shows how throughput, transit time (or latency) and packet loss will vary with different fixed sending rates. For sending rates below T₀, the throughput increases linearly with the sending rate, without any packet loss or increase in latency. For higher sending rates, both increased latency and packet loss occur as the buffers fill. The performance of the link is highly sensitive to fixed sending rates which differ only slightly from the optimal rate. For sending rates only marginally above the optimal, latency will ultimately reach its maximum level, and packet loss will occur. Both increased latency and packet loss are detrimental to real-time applications such as video conferencing.

The present invention creates an improved method of controlling the rate of packet transmission for UDP applications by estimating the power of the link over which the data is transmitted, using the estimated power to establish an optimal window size, and implementing window based control of the transmission rate. The present invention requires that the recipient computer transmit acknowledgments of the packets it receives (although lost packets are not re-transmitted, as in TCP). This function is not provided by the UDP protocol, and must be included in the application which utilizes the present invention. According to the preferred embodiment of the invention, an acknowledgment is transmitted for each packet received. However, modifications can be made to this procedure, such as transmitting acknowledgements for only a specified subset of the received packets, such as every second packet or every third packet.

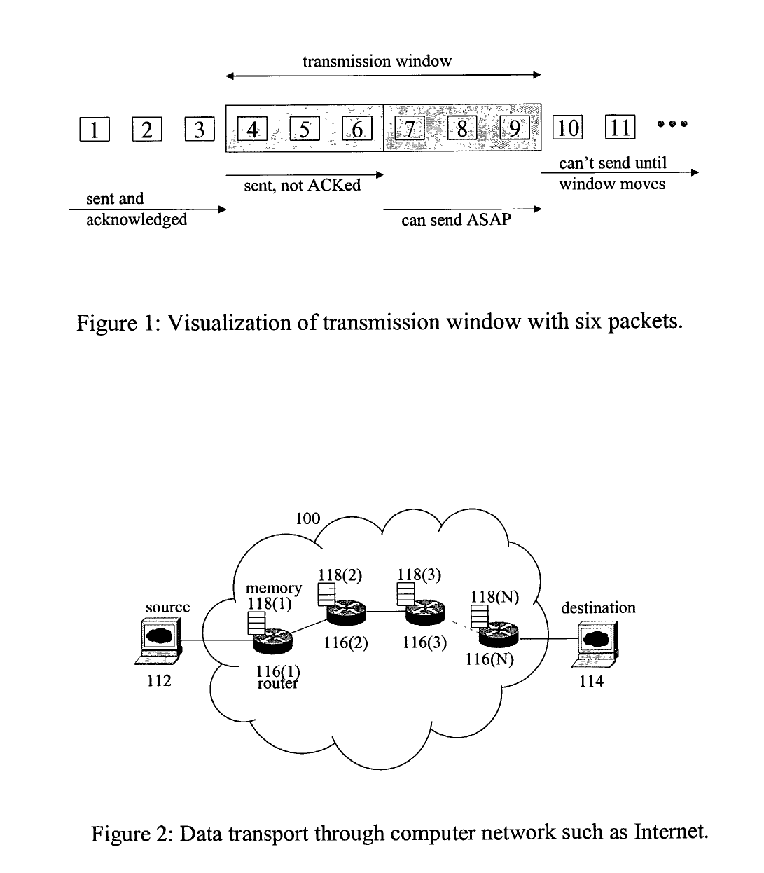

As illustrated in the discussion of FIG. 1, according to the preferred embodiment of the invention, the left edge of the window moves one packet to the right each time an acknowledgement is received, and another packet is added to the window, moving the right edge of the window one packet to the right, to restore the window to its intended size. All packets within the window, and which have not already been transmitted, are available for transmission as soon as the transmitting computer can do so. If acknowledgements are transmitted for only a subset of the transmitted packets, the procedures for moving the left and right edges of the window must be modified accordingly. Those procedures must also take account of potential packet loss—if acknowledgment fails to arrive for a particular packet, but acknowledgments are received for subsequent packets, movements of the window edges must allow for the lost packet. In addition, if the application or transmission protocol in use creates data packets of different sizes, the procedures can be modified to ensure that the window includes the correct amount of data, which may mean a changing number of data packets.

The present invention differs from the window-based control method used by TCP principally in the way that the size of the transmission window is established. TCP establishes the window size by increasing the window size incrementally as transmission proceeds without packet loss, and then decreasing the window size by a specified percentage once packet loss is detected. The present invention adjusts window size as information obtained from the computer network yields updated estimates of the link power, and thus of the optimal window size. According to the preferred embodiment of the invention, the window size is set equal to the estimated power of the link.

As will be apparent to those skilled in the art, many adjustments could be made to the manner in which the window size is specified, such as increasing or reducing the estimated power of the link by a specified percentage, to allow for suspected errors in estimation. As well, different methods can be used to estimate the power of the link between the source and recipient computers.

According to the preferred embodiment of the invention, the power of the link, and the consequential optimum window size, are determined through a local search algorithm. A mathematical objective function is established, which includes as its arguments quantities such as packet round trip time or throughput, which can be determined from data available to the application transmitting the data. The application establishes an initial window size, and then increases the window size during operation. The application measures whether the increase in window size improves performance, as reflected in a better value for the objective function. If so, the window size is increased again. If an increase produces an inferior value for the objective function, the sending window decreases. Through iterations of this process, the optimum window size, which produces the optimal value of the objective function, is identified. If the objective function is suitably chosen, the window size which optimizes the objective function should be equal or close to the power of the network link being used. Many different variations are possible in the manner in which the local search algorithm is implemented. For example, the local search algorithm may use a weighted average of several recent measurements of the arguments of the objective function, to ensure that operation of the algorithm is not distorted by a single anomalous measurements. In addition, the objective function can take a large number of different mathematical forms.

According to another embodiment of the present invention, the power of the link is measured by multiplying one half of the minimum observed round trip time for a data packet (measured by the minimum elapsed time between the transmission of a particular packet and the receipt of an acknowledgement of the packet) by the maximum observed throughput, measured by the amount of data transmitted in a given time interval.

As will be apparent to those skilled in the art in light of the foregoing disclosure, many alterations and modifications are possible in the practice of this invention without departing from the spirit or scope thereof. In addition, the invention may be applied to applications which use packet switched transmission controls other that UDP. Accordingly, the scope of the invention is to be determined according to the following claims.

What is claimed is:

1. A method for controlling the rate of data transmission from a first computer to a second computer over a computer network for an application transmitting data using a packet switched protocol, the method comprising:
(a) the application causing said second computer to transmit to said first computer acknowledgements of packets received from said first computer;
(b) establishing a transmission window which includes a specified number of data packets which either have been transmitted, or which are available for immediate transmission, by said first computer;
(c) decrementing the transmission window upon the receipt of data packet acknowledgments, by removing data packets from the transmission window;
(d) incrementing the transmission window, by adding additional data packets, to restore the transmission window to the specified number of data packets; and
(e) adjusting the specified number of data packets to be included in the transmission window according to at least one measured parameter.

2. The method according to claim 1 wherein the specified number of data packets included in the transmission window is set according to the following procedure:
(a) estimating the power of the network link over which the data is being transmitted; and
(b) calculating a transmission window size based on the power of the link.

3. The method according to claim 2 wherein the specified number of data packets included in the transmission window is set by identifying the number of data packets which results in an optimal value for a mathematical objective function whose arguments include at least one measured value for the throughput of data from said first computer to said second computer and at least one measured value for the round trip time for a data packet from said first computer to said second computer.

4. The method according to claim 3 wherein the number of data packets which results in an optimal value for the mathematical objective function is identified using a local search algorithm.

5. The method according to claim 2 wherein the specified number of data packets included in the transmission window is calculated using a mathematical equation whose arguments are data which are observable by said first computer or said second computer relating to the performance of the network link.

6. The method according to claim 5 wherein the arguments of the mathematical equation include at least one measured value for the throughput of data from said first computer to said second computer and at least one measured value for the round trip time for a data packet from said first computer to said second computer

7. The method according to claim 5 wherein the transmission window size is equal to the product of the maximum observed throughput of the link multiplied by one half of the minimum observed round trip transmission time for a data packet.

8. A method for controlling the rate of data transmission from a first computer to a second computer over a computer network for an application transmitting data using a packet switched protocol, the method comprising:
(a) measuring the round trip time for at least one transmitted data packet;
(b) making at least one measurement of the throughput of the network link over which the data is being transmitted;
(c) using at least one measurement of the round trip time and at least one measurement of the throughput to establish a transmission rate which achieves optimal values for the throughput of data from said first computer to said second computer and for the latency of transmission from said first computer to said second computer.

9. The method according to claim 8 wherein the transmission rate is determined by identifying a transmission rate which optimizes a mathematical objective function whose arguments include at least one measured value for the throughput of data from said first computer to said second computer and at least one measured value for the round trip time for a data packet from said first computer to said second computer.

10. The method according to claim 9 wherein the arguments of the mathematical objective function are the maximum measured value for the throughput of data from said first computer to said second computer and the minimum measured value for the round trip time for a data packet from said first computer to said second computer.

11. The method according to claim 9 wherein the transmission rate which optimizes the mathematical objective function is determined by a local search algorithm.

12. The method according to claim 8 wherein the transmission rate is determined by a mathematical equation whose arguments include at least one measured value for the throughput of data from said first computer to said second computer and at least one measured value for the round trip time for a data packet from said first computer to said second computer.

13. The method according to claim 12 wherein the arguments of the mathematical equation are the maximum measured value for the throughput of data from said first computer to said second computer and the minimum measured value for the round trip time for a data packet from said first computer to said second computer.
